(19) United States
(12) Patent Application Publication
(10) Pub. No.: US 2020/0299516 A1
(43) Pub. Date: Sep. 24, 2020

(54) A METHOD FOR TREATING TITANIUM DIOXIDE PARTICLES, A TITANIUM DIOXIDE PARTICLE AND USES OF THE SAME

(71) Applicants: Venator P&A Finland Oy, Pori (FI); Venator Germany GmbH, Duisburg (DE)

(72) Inventors: Ralf-Johan LAMMINMÄKI, Ulvila (FI); Kaarina HEIKKILÄ, Pori (FI)

(73) Assignees: Venator P&A Finland Oy, Pori (FI); Venator Germany GmbH, Duisburg (DE)

(21) Appl. No.: 16/089,466

(22) PCT Filed: Mar. 29, 2017
(86) PCT No.: PCT/FI2017/050220

§ 371 Date: Sep. 28, 2018

(30) Foreign Application Priority Data
Mar. 29, 2016 (FI) 20165262

(51) Int. Cl. C09C 1/36

(52) U.S. Cl. CPC C09C 1/3661; C09C 1/3684; C01P 2004/62; C01P 2004/64; C01P 2004/80

(57) ABSTRACT

The invention relates to a method for preparing durable titanium dioxide particles. The preparation process includes an aqueous grinding step, which comprising providing an aqueous slurry or dispersion comprising titanium dioxide particles, aluminum containing compound and phosphorous containing compound into grinding equipment. The slurry or dispersion is subjected to an aqueous grinding process, and subsequently titanium dioxide particles having a core of titanium dioxide and a pre-coating layer thereon is obtained, said pre-coating layer containing aluminum and phosphorous containing compounds. The invention further covers the resulting titanium dioxide particles and uses thereof.

The invention relates to a method for producing durable titanium dioxide particles. Moreover, durable titanium dioxide particles are provided. The invention aims in particular at reducing photocatalytic activity (photoactivity) of titanium dioxide particles, which improves weather resistance of plastics, coatings, paints and other materials comprising the durable titanium dioxide particles in outdoor conditions.

### BACKGROUND OF THE INVENTION

Exterior paints provide not only an aesthetic appearance like colour, opacity and gloss, but more importantly, a protective coating for the substrate. Harsh environmental pollutants, moisture and especially radiation of ultra violet light may cause destruction of the substrate material as well as the coating film itself. Changes like decrease of gloss, “chalking”, discoloration and cracking may occur in the paint film during exposure.

When degradation of a pigmented paint film proceeds, a binder does not adhere the titanium dioxide pigment and extender particles to the film anymore and a chalking phenomenon will result. This type of a degradation process is common for resin systems representing not the best weather resistance compared to conventional alkyd paints, for example.

Polymer molecules forming a paint film may undergo light induced degradation. This process is initiated by absorption of light, especially energetic ultra violet light. Polymer molecules on the surface of a paint film undergo degradation into shorter units and are washed out by rain in exterior exposure conditions. Erosion of the surface causes roughness and the gloss of the film decreases.

Titanium dioxide pigment as one of the main components in paint plays a significant role in creating a long-lasting weather durable coating. As titanium dioxide absorbs ultra violet light, incorporation of TiO₂ to an alkyd paint system will protect the resin against UV light radiation and increase the weather durability. Titanium dioxide has a dual role in the photodegradation process of paints. On one hand, it provides protection as described above in case of alkyds, and on the other hand, due to the photocatalytic nature of TiO2 it can initiate a degradation process of the most durable resin systems themselves not susceptible for absorbing UV light. UV light can excite electrons from the valence band of TiO₂ to the conduction band causing formation of free electrons and positive holes. These highly reactive species reaching the surface of a titanium dioxide particle can form radicals with water and oxygen molecules further undergoing chain reactions with binder molecules to cause destruction of the paint polymer.

TiO₂ particles can be prepared by a sulphate process yielding H₂TiO₃, which is calcined to TiO₂ crystals, which tends to form aggregates of a size of a few millimetres. To comminute the aggregates milling operations are carried out, first with a hammer mill or a steam jet mill, and then at a second step by wet-milling.

TiO₂ can exist in three different crystal forms. Rutile is a stable form at high temperatures. Anatase is the prevailing form at low temperatures. At low temperatures, even a brookite form can occur. Rutile is known as the most durable crystal form and its permeability to UV light is lower than that of anatase.

It is a known fact that it is easier to prepare mixtures of anatase and rutile than pure rutile. By calcining titanium dioxide of anatase form in the presence of what are called rutilizing chemicals, such as zinc, for example, a mixture of anatase and rutile can be generated even at lower temperatures. In the preparation of titanium dioxide pigment it is well-known to use pretreatment chemicals to prevent or accelerate the rutilizing of titanium dioxide in particular, and to improve grindability of the calcined product.

The usual titanium dioxide pigment known as white pigment has a crystal size of about 200 to 400 nm. By continued wet milling transparent microcrystalline rutile titanium dioxide may be obtained, having a crystal size of less than 100 nm, e.g. an average size of about 25 nm, and a suitable crystal size distribution, such as from about 10 to 50 nm.

A known approach to control durability of TiO₂ particles is to use inorganic surface treatment to cover or coat the titanium dioxide particles. The surface of TiO₂ will become isolated to prevent photoactive reactions from occurring.

Commercial titanium dioxide pigments for paints are surface coated with inorganic agents. The treatment chemicals generally used are non-colouring hydrated oxides of aluminum, silicon and zirconium. Surface treatment improves several important paint properties. Coated pigments are more easily dispersible and have better dispersion and colour stability and optical performance like hiding power than those of uncoated TiO₂ pigments. In addition, improved weather resistance is achieved.

Photocatalytic degradation reactions take place on the surface of the titanium dioxide in the presence of moisture and oxygen. Inorganic oxide treatment provides a barrier layer between the TiO₂ and polymer binder inhibiting degradation. Hydrous aluminum, silicon and zirconium oxides are especially suitable for this purpose as they destroy the hydroxyl radicals by providing an area for recombination.

Type, thickness and density of the surface coating layer meaningfully influence the weathering performance. The commercial exterior durable rutile TiO₂ pigments have been either Al₂O₃—SiO₂ or Al₂O₃—ZrO₂ treated. Alumina treatment alone does not give as good protection as can be seen by comparing gloss retention of paints prepared of the Al₂O₃ treated pigment to Al₂O₃—SiO₂ and Al₂O₃—ZrO₂ ones with about the same total coating thickness.

It is known that alumina bound to the crystal lattice of TiO₂ is beneficial to photostability. Alumina has been added at the calcination step, but one handicap is that subsequent milling spoils the sought photostability enhancement. To avoid this problem there are methods, in which alumina is first added after calcination and millings to form a coating that holds up to the final drying.

In FI application 20126250 there is described a titanium dioxide pigment comprising a core particle consisting of titanium dioxide, which has a multilayer coating thereon comprising a silicon containing compound layer, an aluminum containing compound layer, a phosphorus containing compound layer and an outer organosilane layer in this order on the surface of said core. According to the reference, preparation of the titanium dioxide pigment comprises the steps of (i) providing an aqueous suspension of titanium dioxide core particles to an elevated temperature, (ii) introducing a silicon containing compound into said slurry the pH of which is made alkaline, (iii) decreasing the pH of said slurry for precipitating a silicon containing layer onto the titanium dioxide core, (iv) introducing an aluminum containing compound into the slurry, the pH of which is acidic, (v) increasing the pH of the slurry to a neutral value, (vi) introducing a phosphate containing compound to the slurry, (vii) filtering the resulting slurry into a suspension cake, (viii) introducing an organosilane compound to said suspension, and (ix) drying the obtained pigment product.

EP 0 444 798 and WO 2009/022061 describe methods for the preparation of microcrystalline rutile titanium dioxide. As microcrystalline titanium dioxide has a decreased permeability to UV radiation, it is well-suited for a UV protective agent. Because of its small crystal size and large specific surface area, microcrystalline titanium dioxide is useful, for example, in cosmetics, catalysts, ceramic materials, and as an effect pigment in paints.

According to WO 2009/022061 the method has steps, in which (i) a titanium dioxide mass obtained from calcination is wet-ground, (ii) the mass obtained from wet-grinding is surface-treated, (iii) the surface-treated mass is filtered and washed, (iv) the mass is wet-ground again, and (v) the mass is spray-dried and spray-ground to prepare the final titanium dioxide product. At the surface-treatment step (ii) the ground titanium dioxide mass obtained at step (i) is coated according to its intended use, for example, with aluminum, silica, and/or zirconium compounds.

The method used can comprise, for example, the processing methods disclosed in patent specification FI 62130. At step (iii) the product is filtered and washed with water. An inorganic coating agglomerates microcrystalline titanium dioxide intensively. At step (iv) the coated titanium dioxide mass is re-elutriated in water and the slurry is wet-ground. Before starting the grinding an organic additive, such as methylol propane, trimethylol propane (TMP), methylol ethane or silicon is added to the feeding slurry before feeding it to the drying plant. The purpose of the grinding is to make the TMP to mix with the feed of the drying plant as evenly as possible. The wet-grinding treatment (iv) after coating (ii) improves the dispersability and the transparency of the microcrystalline titanium dioxide end product. Wet grinding was not observed to increase the photoactivity of the titanium dioxide end product. By adding the wet-grinding stage between the coating and the spray drying, better dispersability was achieved without losing the photostability.

At wet milling dispersing aids or agents are used to stabilize the slurry through control of interactions between the particles. A known dispersing aid for use with TiO₂ is waterglass. Through milling, the properties of the final product are substantially influenced.

Along with good dispersability, in addition to a small crystal size, several applications require a narrow or controlled crystal size distribution, which is essentially influenced by the milling. Additionally, improvements in photostability of titanium dioxide particles are required.

### SUMMARY OF THE INVENTION

The present invention has the goal of finding a novel method of treating titanium dioxide, so as to obtain durable particles with increased photostability, which provide improved durability to objects and applications subjected to outdoor conditions. The particle size of the durable particles obtained by the invention may vary, covering the particle size ranges of both the titanium dioxide for pigment applications and the microcrystalline or ultrafine titanium dioxide.

In the first aspect of the present invention, a method for producing durable titanium dioxide particles is disclosed. It includes an aqueous grinding step, for example after calcination of the titanium dioxide base, which comprises

(i) providing an aqueous slurry or dispersion comprising titanium dioxide particles, aluminum containing compound and phosphorous containing compound into grinding equipment, and
(ii) subjecting the slurry or dispersion to an aqueous grinding process, and subsequently
(iii) obtaining from the aqueous grinding titanium dioxide particles having a core of titanium dioxide and a pre-coating layer thereon said pre-coating layer containing aluminum and phosphorous containing compounds.

The second aspect of the present invention provides the durable TiO₂ product obtained by the method.

Further aspects provide uses of the durable product obtained.

Tests carried out according to the invention show that a remarkable increase in photostability is achieved in comparison with use of only monoisopropanol amine (MIPA) as a standard dispersing aid or agent, or with waterglass as another known dispersing aid for TiO₂. Surprisingly, the improvement is brought about by incorporating aluminum and phosphorus containing compounds in the slurry before the grinding step, such as wet milling step. Up till now, dispersing aids have been used just for maintaining the dispersion by preventing recombination of particles. NMR studies show that during grinding, such as wet milling, aluminum and phosphor containing compounds are precipitated as a unitary coating layer on top of TiO₂ particles/crystals, instead of merely being included in the TiO₂ lattice. The improved photostability translates into markedly improved weather and light resistance in those outdoor applications wherein the durable TiO₂ particles according to the present invention are incorporated.

### FIGURES

FIG. 1 shows the schematic cross-sectional layout of TiO₂ product coated with Al and P containing compounds.

FIGS. 2a, b, c, and d show the particle size distribution, total suspended matter results, chemical analysis by X-ray fluorescence and photostability results of wet-milled samples including 0.3% by weight dispersing agent KemEcal 117-50, 1.0% P₂O₅ and 0.5% Al₂O₃ from sulphate.

FIGS. 3a, b, c, and d show the particle size distribution, total suspended matter results, chemical analysis by X-ray fluorescence and photostability results of wet-milled samples including 1.0% P₂O₅ and 0.5% Al₂O₃ from sulphate without using a dispersing agent.

FIGS. 4a, b, c, and d show the particle size distribution, total suspended matter results, chemical analysis by X-ray fluorescence and photostability results of wet-milled samples including 0.3% by weight MIPA, 1.0% P₂O₅ and 0.5% Al₂O₃ from sulphate.

FIGS. 5a, b, c, and d show the particle size distribution, total suspended matter results, chemical analysis by X-ray fluorescence and photostability results of wet-milled samples including 0.3% by weight waterglass, 1.0% P₂O₅ and 0.5% Al₂O₃ from sulphate.

FIGS. 6a, b, c, and d show the particle size distribution, total suspended matter results, chemical analysis by X-ray fluorescence and photostability results of wet-milled samples including 0.3% by weight TMP, 1.0% P₂O₅ and 0.5% Al₂O₃ from sulphate.

FIGS. 7a, b, c, and d show the particle size distribution, total suspended matter results, chemical analysis by X-ray fluorescence and photostability results of wet-milled samples including 0.6% P₂O₅ and 0.5% Al₂O₃ from sulphate.

FIGS. 8a, b, c, and d show the particle size distribution, total suspended matter results, chemical analysis by X-ray fluorescence and photostability results of wet-milled samples including 1.0% P₂O₅ and 0.7% Al₂O₃ from sulphate.

FIGS. 9a, b, c, and d show the particle size distribution, total suspended matter results, chemical analysis by X-ray fluorescence and photostability results of wet-milled samples including 0.3% by weight waterglass, 1.0% P₂O₅ and 0.5% Al₂O₃ from aluminate.

FIGS. 10a, b, c, and d show the particle size distribution, total suspended matter results, chemical analysis by X-ray fluorescence and photostability results of basic wet-milled samples including 0.3% by weight waterglass, 1.0% P₂O₅ and 0.5% Al₂O₃.

### DETAILED DESCRIPTION

The invention provides a novel method for producing titanium dioxide particles with the characteristics as discussed above and as defined by claim 1. As noted, the particles obtainable by the method are durable i.e. they exhibit improved photostability, especially in demanding applications, which further provides improved weather and light resistance to outdoor applications comprising the particles such as those involving exposure to UV light.

Furthermore, particle size measurements show that the product dimensions may be kept within the usual TiO₂ particle size range. The undertone of the particles may thus be preserved unchanged or even enhanced. Compared to regular microcrystalline TiO₂ the surface area of the inventive product is lower, and moisture content may be decreased.

It is also possible to apply the invention to preparation of microcrystalline TiO₂, which is useful in particular for lacquers, plastics and cosmetic products.

The titanium dioxide particle to be subjected to aqueous grinding in suitable grinding equipment may be prepared in any desired manner, but advantageously it has been obtained by the commercial sulfate or the commercial chloride process, preferably with the sulfate process. These two processes are described in many details in e.g. Volume I of “Pigment Handbook” published by John Wiley & Sons (1988).

In an exemplary embodiment the rutile crystal form of TiO₂ is preferred to the anatase one, and the rutile content of TiO₂ is preferably at least 95%, more preferably at least 97%.

The aqueous grinding may comprise wet milling, which may be performed by regular milling means known in the art, such as bead milling.

In the first step (i) an aqueous slurry or dispersion of titanium dioxide particles, aluminum containing compound and phosphorous containing compound is provided. The titanium dioxide particles, aluminum containing compound and phosphorous containing compound are mixed as to form the aqueous slurry or dispersion. The chemicals forming the slurry or dispersion are introduced into grinding equipment.

In one embodiment the titanium dioxide particles are calcined titanium dioxide particles, preferably calcined and hammer-milled rutile titanium dioxide particles.

In one embodiment, the aluminum containing compound and the phosphorous containing compound are first mixed with water, and the titanium dioxide particles are added to the mixture under continued mixing.

In a preferred embodiment the mixture is in form of a dispersion. The dispersion is produced by any known conventional method.

Optionally, a dispersing aid or agent is added to the slurry, preferably the dispersing aid is water soluble silicate such as sodium and potassium metasilicate, waterglass, amino alcohol such as monoisopropanol amine (MIPA), 2-amino-2-methyl-1-propanol and 2-dimethylamino-2-methyl-1-propanol, trimethylolpropane (TMP), acrylate, salts of polyacrylic acid such as sodium or ammonium polyacrylates. Most preferably, the dispersing aid is MIPA, water glass or acrylate as these chemicals are forming the most suitable dispersions.

Preferably, the dispersing aid, together with the aluminum and phosphorous compounds, are mixed with water, and titanium dioxide is then dispersed to the mixture under continued mixing.

In one embodiment the amount of the dispersing agent is about 0.1 to 0.4% by weight of the silicon compound calculated as SiO₂.

In one embodiment the amount of the dispersing agent is about 0.1 to 0.4% by weight of the amino alcohol.

The viscosity of the slurry or dispersion may vary and is influenced by the chemicals and amounts thereof. The viscosity needs to within the range suitable for grinding in the aqueous grinding equipment.

In one embodiment the viscosity is less than 400 cP, preferably less than 300 cP, more preferably less than 200 cP, most preferably less than 100 cP, such as from 20 to 95 cP. As the viscosity increases the grinding becomes troublesome. For example a bead milling apparatus is difficult to utilize if the viscosity of the slurry is over 100 cP.

The pH of the slurry or dispersion may vary but is preferably from 5 to 10, more preferably from 6 to 9 such as 7. If the pH is over 10, the formed coating on the titanium dioxide particles starts to dissolve. If pH is less than 5, the structure of the formed coating layer may not be of the desired type and the precipitation of the desired component is not enabled. The role of ambient pH in forming an aluminum containing coating layer and/or phosphorus containing coating layer is discussed in detail in the applicant's previous patent publication FI20126250.

The pH of the slurry or dispersion may vary depending on the process for preparation of the TiO₂ particles and on the aluminum and phosphorus containing chemicals used. Moreover, the pH may depend on the TiO2 base material used. Therefore pH adjustment is typically necessary. The pH may be adjusted using regular acids and bases, most preferably mineral acids, such as sulphuric acid or hydrochloric acid and hydroxides, such as sodium or potassium hydroxides.

Precipitation of the Al and P compounds may be pursued from either acidic or basic side.

When the pH of the slurry is acidic obtained durable titanium dioxide particles having a coating containing aluminum and phosphorous compounds is obtained by addition of a base resulting in a final pH close to neutral value.

When the pH of the slurry is basic obtained durable titanium dioxide particle having a coating containing aluminum and phosphorous compounds is obtained by addition of an acid resulting in a final pH close to neutral value.

The amount of aluminum may vary, but is preferably in the slurry or dispersion from 0.2 to 1.5% by weight, more preferably from 0.3 to 1.2%, and most preferably from 0.5 to 0.8%, calculated as Al₂O₃, based on the amount of TiO₂.

Suitable aluminum containing compound for use in the present invention is, for example, sodium aluminate, sodium sulphate or alumina. The aluminum containing compound is included in the slurry and precipitated as amorphous alumina onto TiO₂ pigment particles during grinding. Abundant aluminum is advantageous especially for increasing the photostability. However, flocculating may occur at high Al content.

The amount of phosphorus may vary but is preferably in the slurry or dispersion from 0.2 to 1.7% by weight, preferably from 0.3 to 1.5%, and more preferably from 0.5 to 1.0%, calculated as P₂O₅, based on the amount of TiO₂. Phosphorus is necessary for maintaining Al in dissolved state and decreasing the flocculation. The amount of Al in the dispersion may be increased by increasing the amount of P. Moreover, P effects the preferred Al coordination in the formed pre-coating layer. Phosphorus also improves the milling conditions by raising the viscosity of the dispersion.

The phosphorus containing compound used in the invention is preferably a water-soluble phosphate salt such as sodium hexametaphosphate, metal salt of ortophosphoric acid or phosphoric acid as such, preferably sodium hexametaphosphate, which is incorporated in the slurry or dispersion and then precipitated to form part of the coating layer on the pre-coated TiO₂ pigment particles.

A balance is required for the Al/P content as a larger amount of aluminum reduces photoactivity of the titanium dioxide particle, but viscosity control of the slurry becomes difficult, the aluminum starts to flocculate. Suitable amount of phosphorus evens complications in viscosity control.

In an exemplary embodiment the ratio between P and Al in the dispersion is most suitably from 2.2:1 to 0.8:1.

In the second step (ii) the slurry is subjected to an aqueous grinding process. Preferably, the aqueous grinding process comprises wet milling. Wet milling may be performed by regular milling means known in the art, such as bead milling. Preferably, solid beads are used for grinding having a diameter of 10 cm or less, preferably 2 mm or less, more preferably from 0.6 to 0.2 mm. The beads may comprise e.g. Zr—Si-beads.

The method of the present invention allows grinding of titanium dioxide to a mean particle diameter below 0.4 μm, preferably to a range of 0.2 to 0.4 μm corresponding to regular TiO₂ pigment material. However, preparation of smaller particles, down to microcrystalline TiO₂ of a diameter less than 100 nm, such as from 7 to 100 nm, is possible, as well. The pre-coating layer on the TiO₂ particles is included in said diameter ranges.

In one embodiment aluminum and phosphorous containing compounds are precipitated onto the titanium dioxide particles during the grinding step.

The order of adding the compounds and adjusting the pH may vary.

In an exemplary embodiment the aqueous slurry or dispersion is formed by first mixing the aluminum containing compound and the phosphorous containing compound with water, and subsequently introducing the titanium dioxide particles thereto under continued mixing where after the pH of the formed slurry or dispersion is adjusted.

In another exemplary embodiment the aqueous slurry or dispersion is formed by first mixing the phosphorous containing compound with water, and secondly, introducing the titanium dioxide particles thereto under continued mixing, and subsequently introducing the aluminum containing compound to the mixture, and finally adjusting the pH of the formed slurry or dispersion.

In another exemplary embodiment the aqueous slurry or dispersion is formed by first mixing at least one dispersing agent with water, and secondly, introducing the phosphorous containing compound under continued mixing, and subsequently introducing the titanium dioxide particles thereto under continued mixing, and finally adjusting the pH of the formed slurry or dispersion.

In another exemplary embodiment the alkaline aqueous slurry or dispersion is formed by first mixing at least one dispersing agent with water, and secondly, introducing the phosphorous containing compound under continued mixing, and subsequently adjusting the pH of the formed slurry or dispersion, and finally introducing the titanium dioxide particles thereto under continued mixing.

In the third step (iii) durable titanium dioxide particles having a pre-coating containing aluminum and phosphorous compounds are obtained.

Optionally, the method further comprises filtering, washing and drying the wet milled product to obtain dried titanium dioxide particles having a pre-coating containing aluminum and phosphorous compounds.

Prior to processing the durable pre-coated TiO₂ product further the particles obtained are be subjected to post treatment for enhancing their particle size. The subsequent post-treatment may comprise precipitation of a yet further inorganic layer(s) onto the titanium dioxide particles.

In an embodiment calcined TiO₂ particles, preferably rutile TiO₂ although anatase or a blend of the two are workable as well, are dispersed in an aqueous liquid medium. As a pretreatment calcined TiO₂ aggregates may be hammer-milled or otherwise disintegrated before dispersing them into the aqueous liquid.

In the second aspect, the invention provides durable titanium dioxide particles having a core of titanium dioxide and a pre-coating layer containing aluminum and phosphorous containing compounds, and at least one additional coating layer on said pre-coating layer.

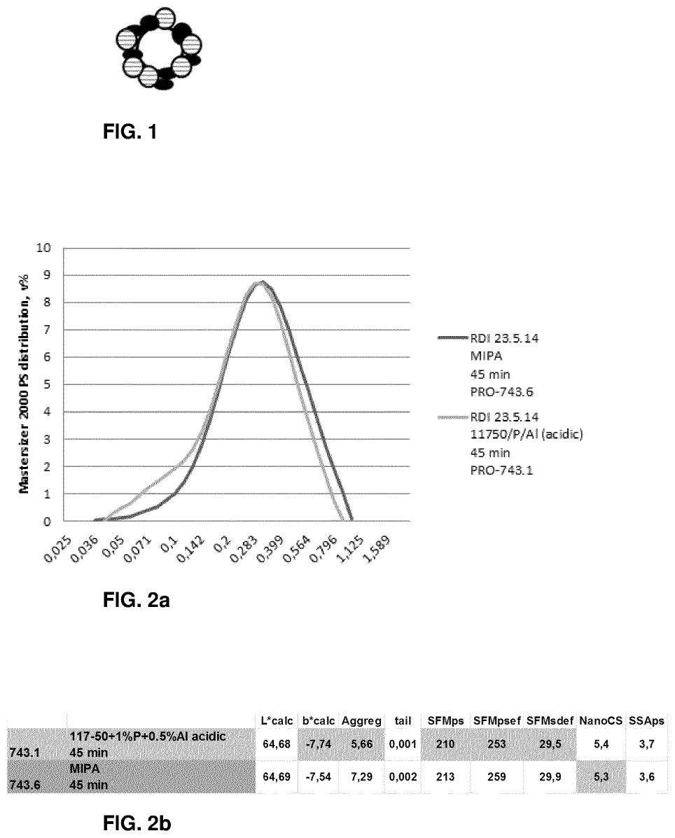

The titanium dioxide particles are coated with the pre-coating layer containing precipitated aluminum and phosphorous containing compounds. These compounds appear as blended in a unitary coating layer on top of the TiO₂ particles as schematically depicted by FIG. 1 (white=TiO₂, black=Al-compound, striped=P-compound). Such a TiO₂ product is obtainable by the method as described above, or as defined in any one of the appended method claims.

In an exemplary embodiment the titanium dioxide particle of the invention including the pre-coating as described above, have a mean particle diameter below 0.4 μm, preferably in the range of 0.2 to 0.4 μm. The coating layer is a very thin one thus not essentially increasing the size of the particles.

The photocatalytic activity of a product may be measured by a method, in which a sample of the product is contacted with isopropanol and UV radiated, so as to convert the isopropanol to acetone and further to carbon dioxide as disclosed in the applicant's prior patent applications. Emergence of said reaction products is detected spectrometrically.

The invention allows preparation of titanium dioxide particles, which have low photocatalytic activity, expressed as the formation rate of acetone, less than 10 ppm/h, preferably less than 5 ppm/h, more preferably less than 3 ppm/h, such as less than 2 ppm/h, or even from 0.1 to 1.5 ppm/h, when the durable pre-coated titanium dioxide particles of the present invention are utilized and further coated with suitable inorganic and/or organic coating layers.

The one or more additional coating layers comprise an inorganic layer and/or an organic layer. Preferably, the additional inorganic layer is coated on the pre-coating layer and the organic layer is coated on the additional inorganic layer. That is, the organic layer is the outermost layer.

The inorganic layer may contain two or more different inorganic layers. Compounds of the inorganic layer(s) are selected from a group consisting of aluminum compounds, zirconium compounds, silicon compounds, phosphorous compounds, or mixtures thereof.

The compounds of the organic layer are selected from a groups consisting of organosilane compound, or mixtures thereof. Preferably, the organic layer comprises lanesiloxane or alkyl silane compound, more preferably an amino-functional oligosiloxane or alkoxy alkyl silane, preferably ethoxy alkyl silane, such as ethoxy octyl silane. The amount of said organosilane layer is preferably from 0.05 to 1.5% by weight of the particles calculated as carbon content, preferably from 0.1 to 1.2%.

In an exemplary embodiment, the photoactivity of the TiO₂ base is about 400 ppm/h. After dry grinding treatment at high temperature the photoactivity is decreased down to about 30 ppm/h, whereas at low temperature treatment the photoactivity is decreased only to about 100 ppm/h. When using a conventional grinding (wet milling) the photocatalytic activity is after milling about 300 ppm/h, whereas after milling according to the present invention using Al and P containing compounds in the wet milling, the photoactivity is decreased down to below 20 ppm/h, as is depicted by the examples shown below. When the pre-coated (or non-coated reference samples) samples are further subjected to post-treatment for increasing the particles size and subsequent coating layers are added on top, the photoactivity of the samples according to the present invention may be decreased down to below 2 ppm/h whereas the photoactivity of the reference samples remains in the range from 3 to 20 ppm/h. This difference is well reflected to the properties of the materials in relevant applications.

In the third aspect, uses according to the present invention of the durable pre-coated titanium dioxide particles as discussed above are provided for manufacturing for manufacturing plastics, coatings, inks and ultrafine titanium dioxide containing products.

In an exemplary embodiment the durable titanium dioxide product is used for increasing photostability or weather resistance of pigmented plastics or coatings in outdoor conditions. The present invention enables the use of Zr free durable pigments in plastics application.

In an exemplary embodiment the durable titanium dioxide product is used for preserving colour and/or gloss of a pigmented plastics or coatings in outdoor conditions.

In an exemplary embodiment the durable titanium dioxide product is used for improving UV blocking in cosmetic products. The product of the present invention is providing a radical free titanium oxide for use in cosmetics.

The invention is further illustrated by the following non-limiting examples.

### EXAMPLES

In the examples the following materials were used:
TiO₂ 164.8 g hammer milled
Calgon PT solution (101.5 g P₂O₅/l)
Al-sulphate solution (79.0 g Al₂O₃/l)
Na-aluminate solution (74.5 g Al₂O₃/l)
KemEcal 117-50 solution (modified sodium acrylate)
MIPA (monoisopropanolamine) solution, standard dispersing aid for TiO₂
Waterglass solution (66 g SiO₂/l), known dispersing aid for TiO₂
TMP (trimethylolpropane) flakes

Zr-beads 552.2 g (0.4-0.6 mm) were used as means for wet milling.

The tests comprise particle size testing, total suspended matter (TSM) measurement, chemical analysis by X-ray fluorescence (XRF) of wet-milled samples and photostability measurements.

The materials were dispersed in a decanter with a magnetic stirrer and mixed for 30 min before wet milling. The mixed dispersions were wet milled with Zr beads for 45 min, and particle size distributions of the milled dispersions were measured with Malvern Mastersizer 2000 particle analyzer. A similarly milled dispersion of TiO₂ and MIPA as a standard dispersion aid was used as a comparison in each example.

Satisfactory wet milling of samples according to the invention does not essentially change the particle size distribution of the resulting milled TiO₂ as compared to the MIPA standard. A product within the regular TiO₂ particle size range was in most cases obtained by the method of the invention.

Photostability of the samples after 45 minutes of wet milling was determined. Photostability, or reduced photocatalytic activity, was measured by contacting a sample with isopropanol and subjecting the combination of the two to UV radiation, which converts the isopropanol to acetone and further to carbon dioxide. Emergence of said reaction products was detected spectrometrically. The results are obtained as formation rates of acetone, expressed as ppm/h.

A high value of acetone formation rate (>300 ppm/h) indicates high photocatalytic activity that is poor photostability, whereas a low value (<20 ppm/h) indicates superior photostability in outdoor conditions. Superior photostability is an indication of a superior durability of an object, e.g. paint, coating or plastic, containing the wet milled TiO₂ pigment when subjected to weather and sunlight outdoors.

It is known that chloride based TiO₂ crystals have better photostability than sulfate ones due to a high amount of burned-in alumina on TiO₂ calciner discharge crystals. NMR studies showed that the superior photostability of TiO₂ crystals as obtained by the invention stems from alumina on the top of TiO₂ crystals (not from alumina in the TiO₂ crystal lattice). In the sample according to the present invention, a coating comprising phosphor and alumina is precipitated on TiO₂ particles during the wet milling process.

### Example 1

Samples according to the present invention (PRO-743.1) were prepared as described using as dispersing agent a modified sodium acrylate solution, KemEcal 117-50, phosphorus source was Calgon PT solution, and aluminum source was the Al-sulphate solution. The amounts of the used chemicals were 0.3% 117-50+1.0% P₂O₅ (Calgon PT)+0.5% Al₂O₃ (Al-sulphate) by weight.

Reference samples (dotted curve) without the P—Al layer were prepared having conventionally only MIPA as dispersing agent (sample PRO-743.6).

The pH of the slurry after addition of P and Al containing chemicals was 2.3. Before wet milling 15 ml 10% by weight NaOH was added yielding pH 7. The solids content before wet milling was 44% by weight.

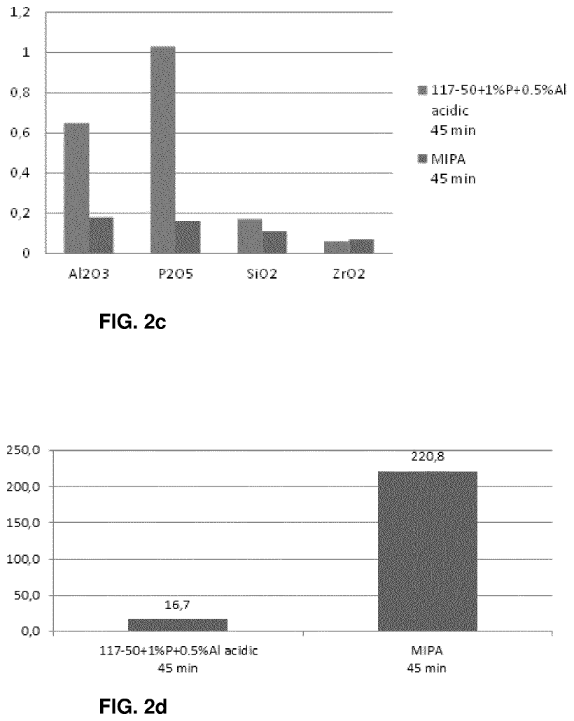

The particle size distribution was measured after 45 min wet milling as depicted in FIG. 2a. As can be seen from FIG. 2a and from table 1 below, the particles having the P—Al coating thereon less coarse particles were obtained.

TABLE 1

| | RDI 23.5.14 | RDI 23.5.14 |
|---|---|---|
| | MIPA | 11750/P/Al (acidic) |
| | 45 min | 45 min |
| MS2000 | PRO-743.6 | PRO-743.1 |
| D(0.1) | 0.162 | 0.122 |
| D(0.5) | 0.326 | 0.293 |
| D(0.9) | 0.624 | 0.546 |

After wet milling samples having the P—Al coating thereon more fine particles of less than 100 μm were obtained compared to the reference samples.

TSM results after 45 min wet milling are shown in FIG. 2b. A bluer undertone (b'calc=−7.74) was obtained and less aggregates (Aggreg=5.66) than with the reference sample (b'calc=−7.54 and Aggreg=7.29). The particle size (SFMps=210/SFMpsef=253) was smaller and the particle size distribution (SFMsdef=29.5) was more narrow than in the reference sample.

Chemical analyses was performed by x-ray fluorescence (XRF) on 45 min wet milled sample including calciner pre-treatment chemicals (no washing). The results are shown in FIG. 2c. Aluminum and phosphorous were precipitated as predicted.

Photostability was measured after 45 min of wet milling and after 3 times washing the samples (C-content 0.05%). FIG. 2 d shows the acetone formation rates. The clearly lowered acetone formation rate of the P—Al coated sample indicates considerably increased photostability.

### Example 2

Samples according to the present invention (PRO-743.2) were prepared as described using as phosphorus source Calgon PT solution, and as aluminum source the Al-sulphate solution. The amounts of the used chemicals were 1.0% P₂O₅ (Calgon PT)+0.5% Al₂O₃ (Al-sulphate).

Reference samples (dotted curve) without the P—Al layer were prepared having conventionally only MIPA as dispersing agent (sample PRO-743.6).

The pH of the slurry after addition of P and Al containing chemicals was 2.3. Before wet milling 15 ml 10% NaOH was added yielding pH 7. The solids content before wet milling was 45%.

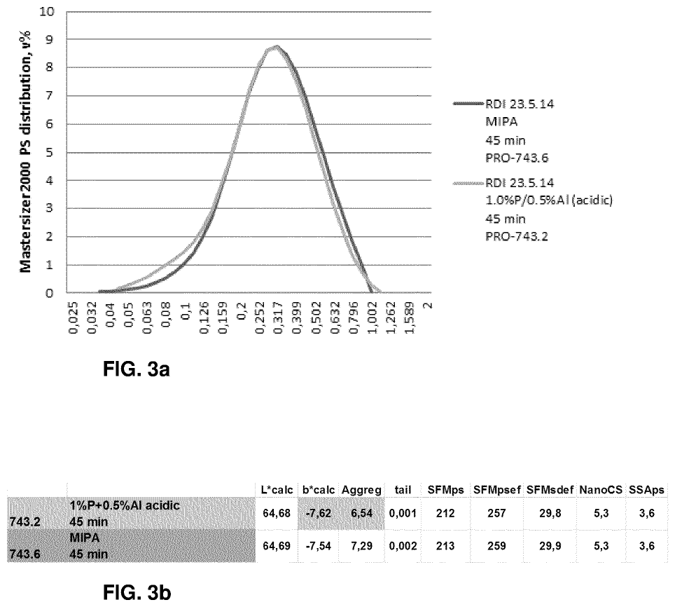

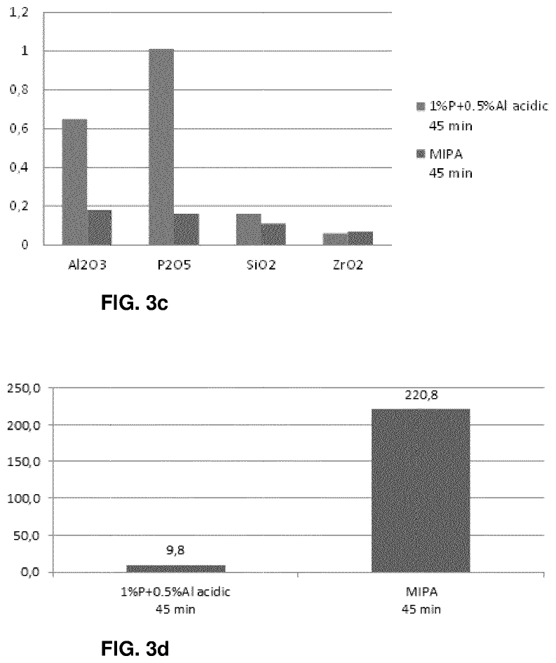

The particle size distribution was measured after 45 min wet milling as depicted in FIG. 3a. As can be seen from FIG. 3a and from table 2 below, for the particles having the P—Al coating thereon slightly less coarse particles were obtained.

TABLE 2

| | RDI 23.5.14 | RDI 23.5.14 |
|---|---|---|
| | MIPA | 1.0% P/0.5% Al (acidic) |
| | 45 min | 45 min |
| MS2000 | PRO-743.6 | PRO-743.2 |
| D(0.1) | 0.162 | 0.142 |
| D(0.5) | 0.326 | 0.311 |
| D(0.9) | 0.624 | 0.593 |

After wet milling samples having the P—Al coating thereon more fine particles of less than 100 μm were obtained compared to the reference samples.

TSM results after 45 min wet milling are shown in FIG. 3b. A bluer undertone (b'calc=−7.62) was obtained and less aggregates (Aggreg=6.54) than with the reference sample (b'calc=−7.54 and Aggreg=7.29). The particle size (SFMps=212/SFMpsef=257) was smaller and the particle size distribution (SFMsdef=29.8) was more narrow than in the reference sample.

Chemical analyses was performed by x-ray fluorescence (XRF) on 45 min wet milled sample including calciner pre-treatment chemicals (no washing). The results are shown in FIG. 3c. Aluminum and phosphorous were precipitated as predicted.

Photostability was measured after 45 min of wet milling and after 3 times washing the samples (C-content 0.03%). FIG. 3 d shows the acetone formation rates. The clearly lowered acetone formation rate of the P—Al coated sample indicates considerably increased photostability.

### Example 3

Samples according to the present invention (PRO-743.3) were prepared as described using as dispersing agent MIPA, as phosphorus source Calgon PT solution, and as aluminum source the Al-sulphate solution. The amounts of the used chemicals were 0.3% MIPA+1.0% P₂O₅ (Calgon PT)+0.5% Al₂O₃ (Al-sulphate).

Reference samples (dotted curve) without the P—Al layer were prepared having conventionally only MIPA as dispersing agent (sample PRO-743.6).

The pH of the slurry after addition of P and Al containing chemicals was 2.3. Before wet milling 13 ml 10% NaOH was added yielding pH 7. The solids content before wet milling was 45%. The dispersion was opaque after addition of the dispersing agent.

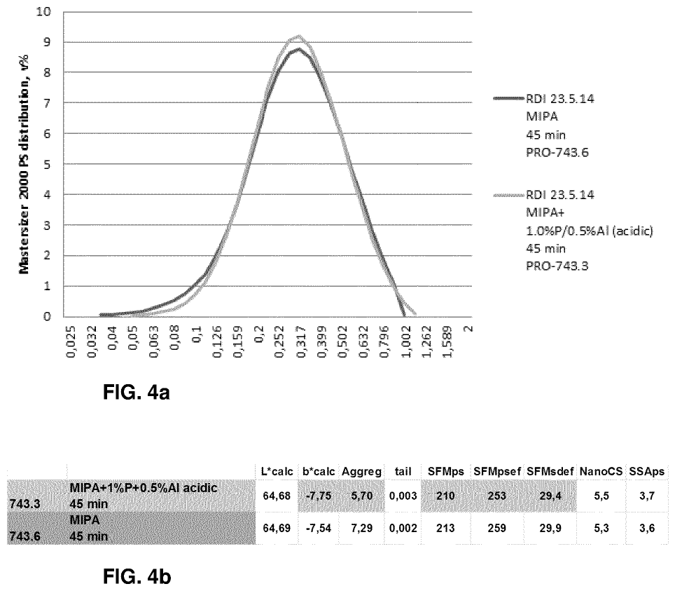

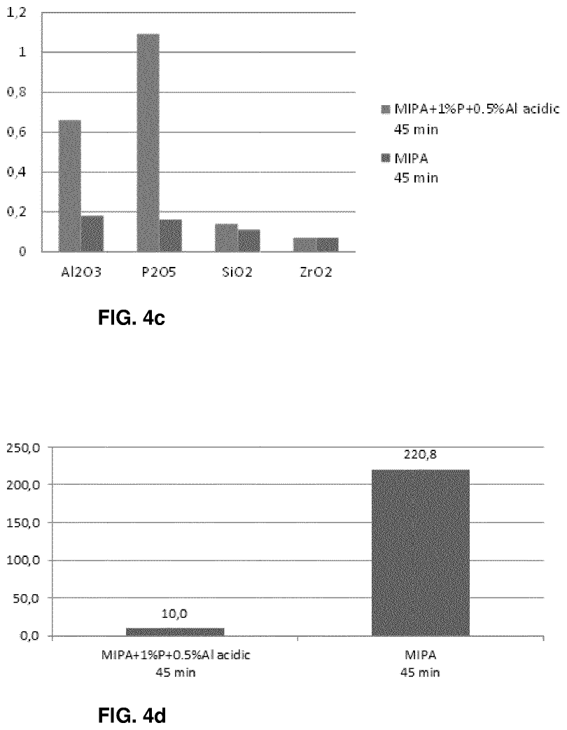

The particle size distribution was measured after 45 min wet milling as depicted in FIG. 4a. As can be seen from FIG. 4a and from table 3 below, for the particles having the P—Al coating thereon better particle size distribution was obtained.

TABLE 3

| | | RDI 23.5.14 |
|---|---|---|
| | RDI 23.5.14 | MIPA + |
| | MIPA | 1.0% P/0.5% Al (acidic) |
| | 45 min | 45 min |
| MS2000 | PRO-743.6 | PRO-743.3 |
| D(0.1) | 0.162 | 0.174 |
| D(0.5) | 0.326 | 0.329 |
| D(0.9) | 0.624 | 0.618 |

After wet milling samples having the P—Al coating thereon more fine particles of less than 100 μm were obtained compared to the reference samples.

TSM results after 45 min wet milling are shown in FIG. 4b. A bluer undertone (b'calc=−7.75) was obtained and less aggregates (Aggreg=5.70) than with the reference sample (b'calc=−7.54 and Aggreg=7.29). The particle size (SFMps=210/SFMpsef=253) was smaller and the particle size distribution (SFMsdef=29.4) was more narrow than in the reference sample.

Chemical analyses was performed by x-ray fluorescence (XRF) on 45 min wet milled sample including calciner pre-treatment chemicals (no washing). The results are shown in FIG. 4c. Aluminum and phosphorous were precipitated as predicted.

Photostability was measured after 45 min of wet milling and after 3 times washing the samples (C-content 0.01%). FIG. 4d shows the acetone formation rates. The clearly lowered acetone formation rate of the P—Al coated sample indicates considerably increased photostability.

### Example 4

Samples according to the present invention (PRO-743.4) were prepared as described using as dispersing agent waterglass, as phosphorus source Calgon PT solution, and as aluminum source the Al-sulphate solution. The amounts of the used chemicals were 0.3% SiO₂ (waterglass)+1.0% P₂O₅ (Calgon PT)+0.5% Al₂O₃ (Al-sulphate).

Reference samples (dotted curve) without the P—Al layer were prepared having conventionally only MIPA as dispersing agent (sample PRO-743.6).

The pH of the slurry after addition of P and Al containing chemicals was 2.3. Before wet milling 7 ml 10% NaOH was added yielding pH 7. The solids content before wet milling was 45%.

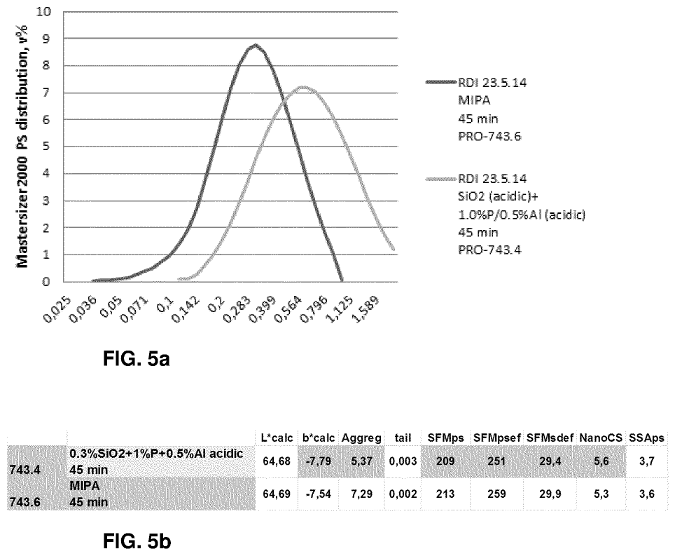

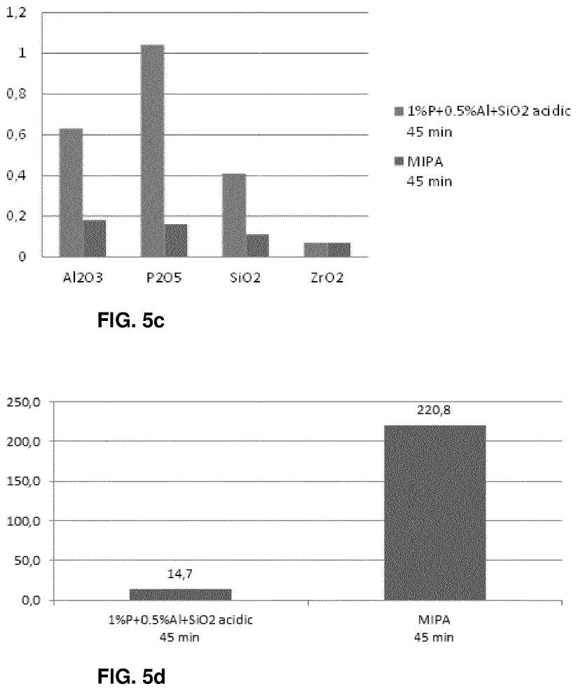

The particle size distribution was measured after 45 min wet milling as depicted in FIG. 5a. As can be seen from FIG. 5a and from table 4 below, for the particles having the P—Al coating thereon the particle size distribution was not as good as would have been expected.

TABLE 4

| | | RDI 23.5.14 |
|---|---|---|
| | RDI 23.5.14 | SiO2 (acidic) + |
| | MIPA | 1.0% P/0.5% Al (acidic) |
| | 45 min | 45 min |
| MS2000 | PRO-743.6 | PRO-743.4 |
| D(0.1) | 0.162 | 0.295 |
| D(0.5) | 0.326 | 0.642 |
| D(0.9) | 0.624 | 1.420 |

After wet milling samples having the P—Al coating thereon more fine particles of less than 100 μm were obtained compared to the reference samples.

TSM results after 45 min wet milling are shown in FIG. 5b. A bluer undertone (b'calc=−7.79) was obtained and less aggregates (Aggreg=5.37) than with the reference sample (b'calc=−7.54 and Aggreg=7.29). The particle size (SFMps=209/SFMpsef=251) was smaller and the particle size distribution (SFMsdef=29.4) was more narrow than in the reference sample.

Chemical analyses was performed by x-ray fluorescence (XRF) on 45 min wet milled sample including calciner pre-treatment chemicals (no washing). The results are shown in FIG. 5c. Aluminum and phosphorous were precipitated as predicted.

Photostability was measured after 45 min of wet milling and after 3 times washing the samples (C-content 0.01%). FIG. 5d shows the acetone formation rates. The clearly lowered acetone formation rate (14.7 ppm/h) of the P—Al coated sample indicates considerably increased photostability.

### Example 5

Samples according to the present invention (PRO-743.5) were prepared as described using as dispersing agent TMP, as phosphorus source Calgon PT solution, and as aluminum source the Al-sulphate solution. The amounts of the used chemicals were 0.3% TMP+1.0% P₂O₅ (Calgon PT)+0.5% Al₂O₃ (Al-sulphate).

Reference samples (dotted curve) without the P—Al layer were prepared having conventionally only MIPA as dispersing agent (sample PRO-743.6).

The pH of the slurry after addition of P and Al containing chemicals was 2.3. Before wet milling 9 ml 10% NaOH was added yielding pH 7. The solids content before wet milling was 46%.

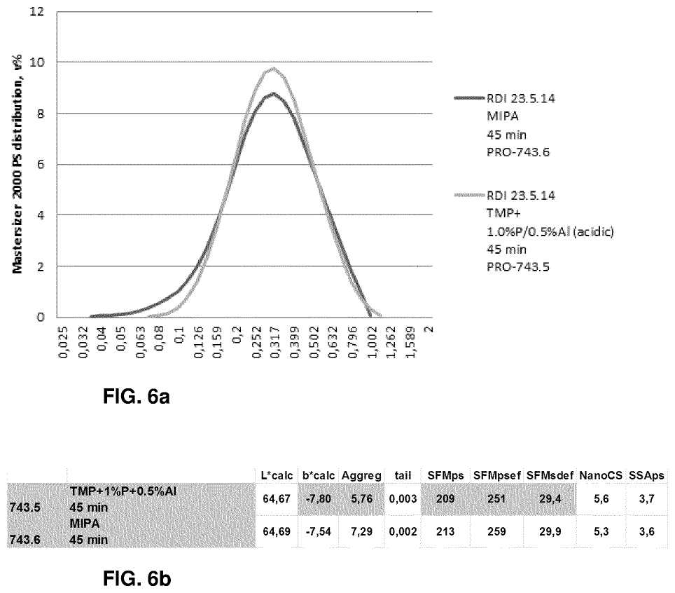

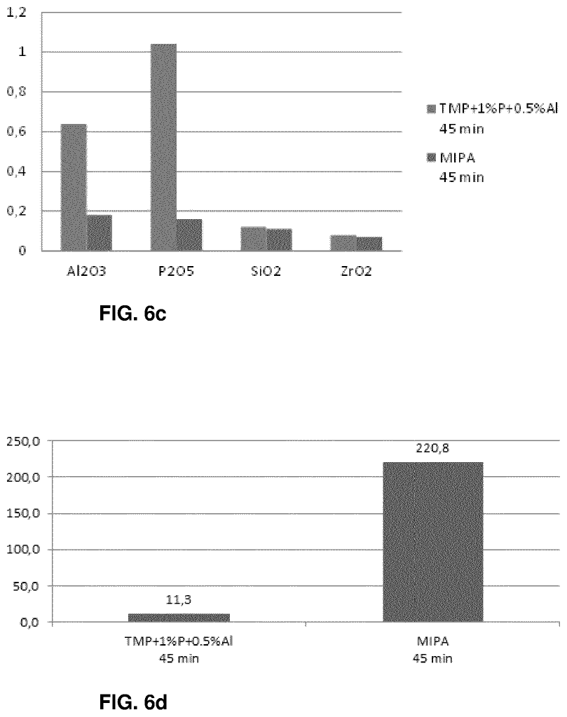

The particle size distribution was measured after 45 min wet milling as depicted in FIG. 5a. As can be seen from FIG. 6a and from table 5 below, for the particles having the P—Al coating thereon better particle size distribution was obtained.

TABLE 5

| | | RDI 23.5.14 |
|---|---|---|
| | RDI 23.5.14 | TMP + |
| | MIPA | 1.0% P/0.5% Al (acidic) |
| | 45 min | 45 min |
| MS2000 | PRO-743.6 | PRO-743.5 |
| D(0.1) | 0.162 | 0.186 |
| D(0.5) | 0.326 | 0.333 |
| D(0.9) | 0.624 | 0.605 |

After wet milling samples having the P—Al coating thereon more fine particles of less than 100 μm were obtained compared to the reference samples.

TSM results after 45 min wet milling are shown in FIG. 6b. A bluer undertone (b'calc=−7.80) was obtained and less aggregates (Aggreg=5.76) than with the reference sample (b'calc=−7.54 and Aggreg=7.29). The particle size (SFMps=209/SFMpsef=251) was smaller and the particle size distribution (SFMsdef=29.4) was more narrow than in the reference sample.

Chemical analyses was performed by x-ray fluorescence (XRF) on 45 min wet milled sample including calciner pre-treatment chemicals (no washing). The results are shown in FIG. 6c. Aluminum and phosphorous were precipitated as predicted.

Photostability was measured after 45 min of wet milling and after 3 times washing the samples (C-content 0.05%). FIG. 6d shows the acetone formation rates. The clearly lowered acetone formation rate (14.7 ppm/h) of the P—Al coated sample indicates considerably increased photostability.

### Example 6

Samples according to the present invention (PRO-743.7) were prepared as described using as phosphorus source Calgon PT solution, and as aluminum source the Al-sulphate solution. The amounts of the used chemicals were 0.6% P₂O₅ (Calgon PT)+0.5% Al₂O₃ (Al-sulphate).

Reference samples (dotted curve) without the P—Al layer were prepared having conventionally only MIPA as dispersing agent (sample PRO-743.6).

The pH of the slurry after addition of P and Al containing chemicals was 2.3. Before wet milling 10% NaOH was added until pH 7 was reached. The solids content before wet milling was 47%.

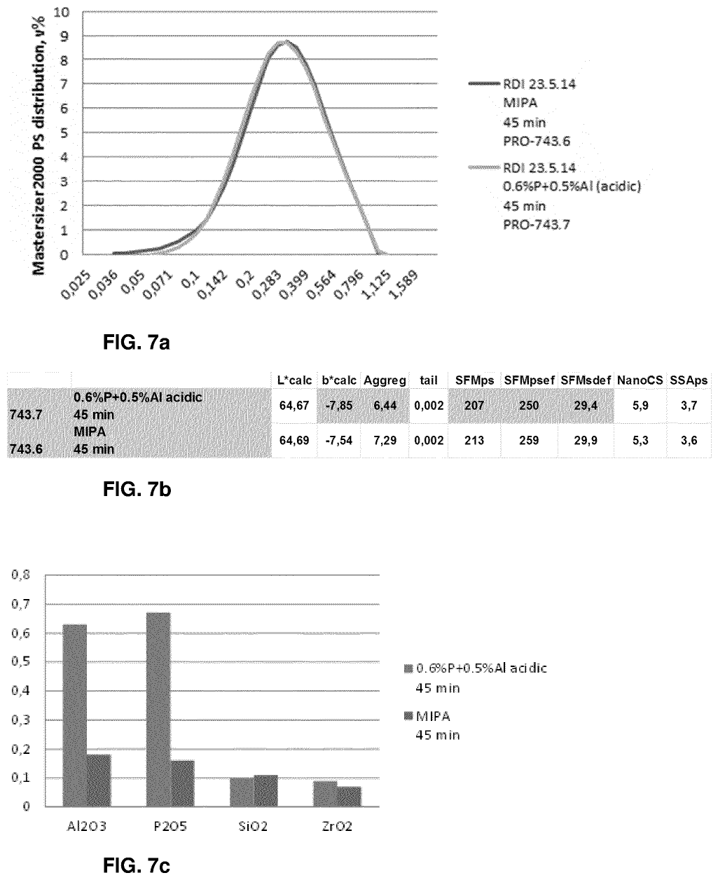

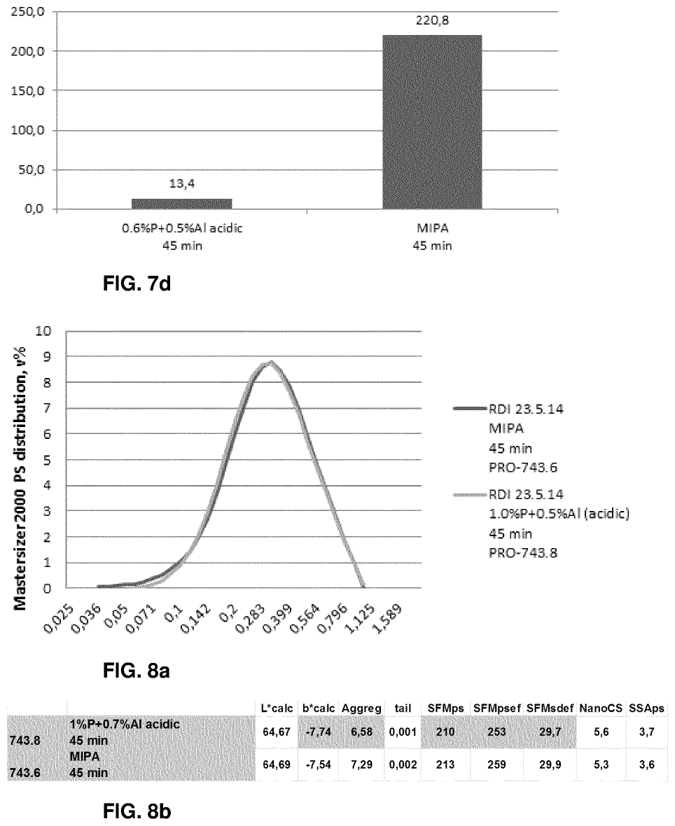

The particle size distribution was measured after 45 min wet milling as depicted in FIG. 7a. As can be seen from FIG. 7a and from table 6 below, for the particles having the P—Al coating thereon better particle size distribution was obtained.

TABLE 6

| | | RDI 23.5.14 |
|---|---|---|
| | RDI 23.5.14 | 0.6% P + |
| | MIPA | 0.5% Al (acidic) |
| | 45 min | 45 min |
| MS2000 | PRO-743.6 | PRO-743.7 |
| D(0.1) | 0.162 | 0.167 |
| D(0.5) | 0.326 | 0.322 |
| D(0.9) | 0.624 | 0.623 |

After wet milling samples having the P—Al coating thereon more fine particles of less than 100 μm were obtained compared to the reference samples.

TSM results after 45 min wet milling are shown in FIG. 7b. A bluer undertone (b'calc=−7.85) was obtained and less aggregates (Aggreg=6.44) than with the reference sample (b'calc=−7.54 and Aggreg=7.29). The particle size (SFMps=207/SFMpsef=250) was smaller and the particle size distribution (SFMsdef=29.4) was more narrow than in the reference sample.

Chemical analyses was performed by x-ray fluorescence (XRF) on 45 min wet milled sample including calciner pre-treatment chemicals (no washing). The results are shown in FIG. 7c. Aluminum and phosphorous were precipitated as predicted.

Photostability was measured after 45 min of wet milling and after 3 times washing the samples (C-content 0.03%). FIG. 7d shows the acetone formation rates. The clearly lowered acetone formation rate (13.4 ppm/h) of the P—Al coated sample indicates considerably increased photostability.

### Example 7

Particle size distribution after 45 min wet milling:

Samples according to the present invention (PRO-743.8) were prepared as described using as phosphorus source Calgon PT solution, and as aluminum source the Al-sulphate solution. The amounts of the used chemicals were 1.0% P₂O₅ (Calgon PT)+0.7% Al₂O₃ (Al-sulphate).

Reference samples (dotted curve) without the P—Al layer were prepared having conventionally only MIPA as dispersing agent (sample PRO-743.6).

The pH of the slurry after addition of P and Al containing chemicals was acidic. Before wet milling 10% NaOH was added until pH 7 was reached. The solids content before wet milling was 46%.

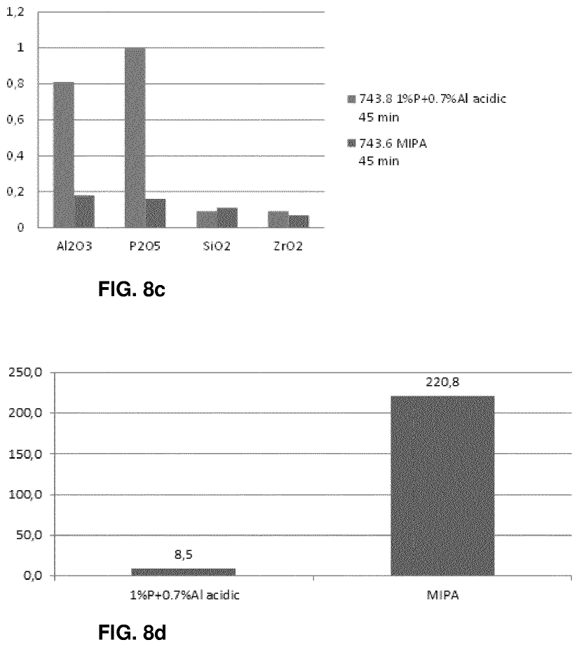

The particle size distribution was measured after 45 min wet milling as depicted in FIG. 8a. As can be seen from FIG. 8a and from table 7 below, for the particles having the P—Al coating thereon better particle size distribution was obtained.

TABLE 7

| | | RDI 23.5.14 |
|---|---|---|
| | RDI 23.5.14 | 1.0% P + |
| | MIPA | 0.5% Al (acidic) |
| | 45 min | 45 min |
| MS2000 | PRO-743.6 | PRO-743.8 |
| D(0.1) | 0.162 | 0.167 |
| D(0.5) | 0.326 | 0.322 |
| D(0.9) | 0.624 | 0.622 |

Chemical analyses of 45 min wet milled sample including calciner pre-treatment chemicals:

After wet milling samples having the P—Al coating thereon more fine particles of less than 100 μm were obtained compared to the reference samples.

TSM results after 45 min wet milling are shown in FIG. 8b. A bluer undertone (b'calc=−7.74) was obtained and less aggregates (Aggreg=6.58) than with the reference sample (b'calc=−7.54 and Aggreg=7.29). The particle size (SFMps=210/SFMpsef=253) was smaller and the particle size distribution (SFMsdef=29.7) was more narrow than in the reference sample.

Chemical analyses was performed by x-ray fluorescence (XRF) on 45 min wet milled sample including calciner pre-treatment chemicals (no washing). The results are shown in FIG. 8c. Aluminum and phosphorous were precipitated as predicted.

Photostability was measured after 45 min of wet milling and after 3 times washing the samples (C-content 0.01%). FIG. 8d shows the acetone formation rates. The clearly lowered acetone formation rate (8.5 ppm/h) of the P—Al coated sample indicates considerably increased photostability.

### Example 8

Samples according to the present invention (PRO-743.10) were prepared as described using as dispersing agent waterglass, as phosphorus source Calgon PT solution, and as aluminum source the Al-sulphate solution. The amounts of the used chemicals were 0.3% of SiO₂ (waterglass)+1.0% of P₂O₅+0.5% of Al₂O₃ (Na-aluminate).

Reference samples (dotted curve) without the P—Al layer were prepared having conventionally only MIPA as dispersing agent (sample PRO-743.6).

The pH of the slurry after addition of P and Al containing chemicals was 12.2. Before wet milling 10% H₂SO₄ was added until pH 9.2 was reached. The solids content before wet milling was 45%.

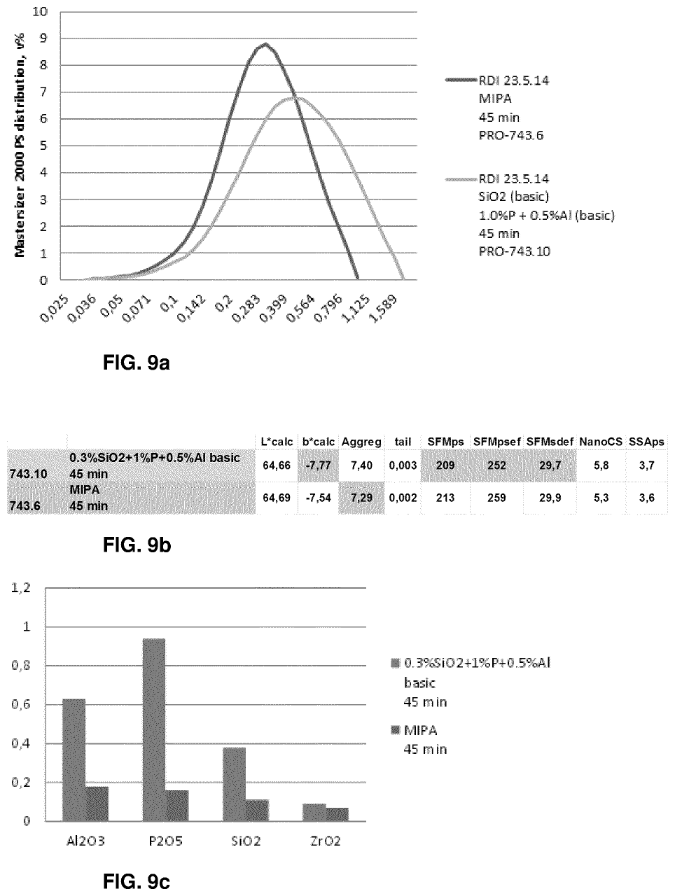

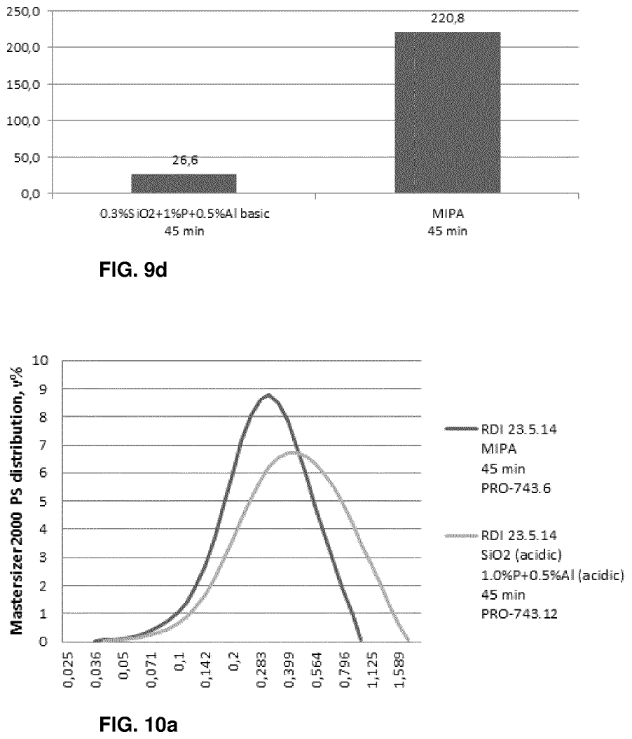

The particle size distribution was measured after 45 min wet milling as depicted in FIG. 9a. As can be seen from FIG. 9a and from table 8 below, for the particles having the P—Al coating thereon better particle size distribution was obtained.

TABLE 8

| | | RDI 23.5.14 |
|---|---|---|
| | | SiO2 (basic) + |
| | RDI 23.5.14 | 1.0% P + |
| | MIPA | 0.5% Al (basic) |
| | 45 min | 45 min |
| MS2000 | PRO-743.6 | PRO-743.10 |
| D(0.1) | 0.162 | 0.176 |
| D(0.5) | 0.326 | 0.420 |
| D(0.9) | 0.624 | 0.932 |

Chemical analyses of 45 min wet milled sample including calciner pre-treatment chemicals.

After wet milling samples having the P—Al coating thereon more fine particles of less than 100 μm were obtained compared to the reference samples.

TSM results after 45 min wet milling are shown in FIG. 9b. A bluer undertone (b'calc=−7.77) was obtained but the amount of aggregates (Aggreg=7.40) was more than with the reference sample (b'calc=−7.54 and Aggreg=7.29). The particle size (SFMps=209/SFMpsef=252) was smaller and the particle size distribution (SFMsdef=29.7) was more narrow than in the reference sample.

Chemical analyses was performed by x-ray fluorescence (XRF) on 45 min wet milled sample including calciner pre-treatment chemicals (no washing). The results are shown in FIG. 9c. Aluminum and phosphorous were precipitated as predicted.

Photostability was measured after 45 min of wet milling and after 3 times washing the samples (C-content 0.01%). FIG. 9d shows the acetone formation rates. The clearly lowered acetone formation rate (26.6 ppm/h) of the P—Al coated sample indicates considerably increased photostability.

### Example 9

Samples according to the present invention (PRO-743.12) were prepared as described using as dispersing agent waterglass, as phosphorus source Calgon PT solution, and as aluminum source the Al-sulphate solution. The amounts of the used chemicals were 0.3% of SiO₂ (waterglass)+1.0% of P₂O₅+0.5% of Al₂O₃ (Al-sulphate)

Reference samples (dotted curve) without the P—Al layer were prepared having conventionally only MIPA as dispersing agent (sample PRO-743.6).

The pH of the slurry after addition of P and Al containing chemicals was 2.6. Before wet milling 3 ml 10% NaOH was added until pH 6.5 was reached. The solids content before wet milling was 45%.

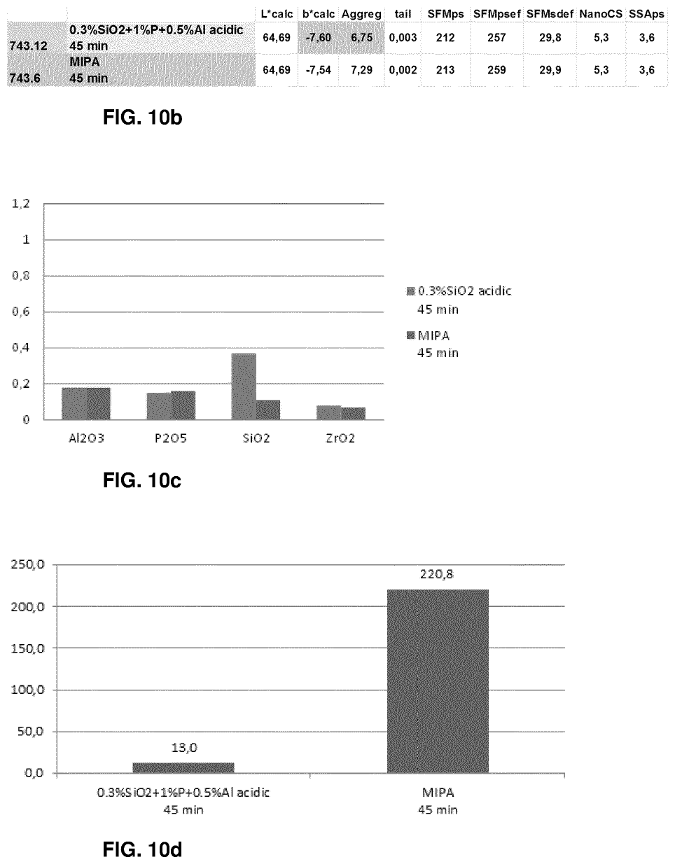

The particle size distribution was measured after 45 min wet milling as depicted in FIG. 10a. As can be seen from FIG. 10a and from table 9 below, for the particles having the P—Al coating thereon better particle size distribution was obtained.

TABLE 9

| | | RDI 23.5.14 |
|---|---|---|
| | | SiO2 (acidic) + |
| | RDI 23.5.14 | 1.0% P + |
| | MIPA | 0.5% Al (acidic) |
| | 45 min | 45 min |
| MS2000 | PRO-743.6 | PRO-743.12 |
| D(0.1) | 0.162 | 0.404 |
| D(0.5) | 0.326 | 0.662 |
| D(0.9) | 0.624 | 1.071 |

Chemical analyses of 45 min wet milled sample including calciner pre-treatment chemicals.

After wet milling samples having the P—Al coating thereon more fine particles of less than 100 μm were obtained compared to the reference samples.

TSM results after 45 min wet milling are shown in FIG. 10b. A bluer undertone (b'calc=−7.60) was obtained with less aggregates (Aggreg=6.75) than with the reference sample (b'calc=−7.54 and Aggreg=7.29). The particle size (SFMps=212/SFMpsef=257) was smaller and the particle size distribution (SFMsdef=29.8) was more narrow than in the reference sample.

Chemical analyses was performed by x-ray fluorescence (XRF) on 45 min wet milled sample including calciner pre-treatment chemicals (no washing). The results are shown in FIG. 10c. Aluminum and phosphorous were precipitated as predicted.

Photostability was measured after 45 min of wet milling and after 3 times washing the samples (C-content 0.01%). FIG. 10d shows the acetone formation rates. The clearly lowered acetone formation rate (13.0 ppm/h) of the P—Al coated sample indicates considerably increased photostability.

1. A method for preparing durable titanium dioxide particles, wherein the preparation process includes an aqueous grinding step, comprising
(i) providing an aqueous slurry or dispersion comprising titanium dioxide particles, aluminum containing compound and phosphorous containing compound into grinding equipment, and
(ii) subjecting the slurry or dispersion to an aqueous grinding process, and subsequently
(iii) obtaining from the aqueous grinding process titanium dioxide particles having a core of titanium dioxide and a pre-coating layer thereon, said pre-coating layer containing aluminum and phosphorous containing compounds.

2. The method of claim 1, wherein the preparation process includes an aqueous grinding step after calcination of the titanium dioxide base.

3. The method of claim 1 or 2, wherein the mean particle size of the titanium dioxide particles in step (i) is from 7 nm to 900 nm.

4. The method of claim 1 or 2, wherein the titanium dioxide particles have rutile crystal form, and the rutile content is preferably at least 95% by weight.

5. The method of any one of claims 1-4, wherein the aqueous slurry or dispersion in step (i) is formed by first mixing the aluminum containing compound and the phosphorous containing compound with water, and subsequently introducing the titanium dioxide particles thereto under continued mixing where after the pH of the formed slurry or dispersion is adjusted.

6. The method of any one of claims 1-4, wherein the aqueous slurry or dispersion in step (i) is formed by first mixing the phosphorous containing compound with water, and secondly, introducing the titanium dioxide particles thereto under continued mixing, and subsequently introducing the aluminum containing compound to the mixture, and finally adjusting the pH of the formed slurry or dispersion.

7. The method of any one of claims 1-4, wherein the aqueous slurry or dispersion in step (i) is formed by first mixing at least one dispersing agent with water, and secondly, introducing the phosphorous containing compound under continued mixing, and subsequently introducing the titanium dioxide particles thereto under continued mixing, and finally adjusting the pH of the formed slurry or dispersion.

8. The method of any one of claims 1-4, wherein an alkaline aqueous slurry or dispersion in step (i) is formed by first mixing at least one dispersing agent with water, and secondly, introducing the phosphorous containing compound under continued mixing, and subsequently adjusting the pH of the formed slurry or dispersion, and finally introducing the titanium dioxide particles thereto under continued mixing.

9. The method of claim 7 or 8, wherein the dispersing agent is selected from the group consisting of sodium and potassium metasilicate, waterglass, amino alcohol, 2-amino-2-methyl-1-propanol, 2-dimethyl-amino-2-methyl-1-propanol, trimethylol propane (TMP), acrylate and salt of polyacrylic acid.

10. The method of any one of the preceding claims, wherein viscosity of the slurry or dispersion is less than 400 cP, preferably less than 300 cP, more preferably less than 200 cP, most preferably less than 100 cP, such as 20-95 cP, when subjecting the slurry to the aqueous grinding process.

11. The method of any one of the previous claims, wherein pH of the slurry or dispersion during the aqueous grinding process is from 5 to 10, preferably from 6 to 9, more preferably from 6.8 to 7.5.

12. The method of any one of the preceding claims, wherein the amount of aluminum, calculated as Al₂O₃, in the slurry or dispersion of step (i) is from 0.2 to 1.5% by weight, preferably from 0.3 to 1.2% by weight and more preferably from 0.5 to 0.8% by weight, based on the amount of TiO₂.

13. The method of any one of the preceding claims, wherein the amount of phosphor, calculated as P₂O₅, in the slurry or dispersion of step (i) is from 0.2 to 1.7% by weight, preferably from 0.3 to 1.5% by weight, more preferably from 0.5 to 1.0% by weight, based on the amount of TiO₂.

14. The method of any one of the preceding claims, wherein the pre-coated titanium dioxide particles obtained from step (iii) are subjected to post-treatment for increasing the particle size thereof.

15. The method of claim 14, wherein at least one additional coating layer is deposited on said pre-coated and post-treated titanium dioxide particles.

16. The method of claim 15, wherein the pre-coated and post-treated titanium dioxide particles are further filtered, washed and dried.

17. Titanium dioxide particles having a core of titanium dioxide and a pre-coating layer containing aluminum and phosphorous containing compounds, preferably manufactured according to any one of the method claims 1-16, and at least one additional coating layer on said pre-coating layer.

18. The titanium dioxide particles according to claim 17, wherein the additional coating layer comprises at least one inorganic layer and/or an organic layer.

19. The titanium dioxide particles according to claim 18, wherein the additional inorganic layer is on the pre-coating layer and the organic layer is on the additional inorganic layer.

20. The titanium dioxide particles according to any one of claims 17-19, wherein the inorganic layer comprises aluminum containing compounds, zirconium containing compounds, silicon containing compounds, phosphorous containing compounds, or any mixtures thereof.

21. The titanium dioxide particles according to any one of claims 18-20, wherein the organic layer comprises an organosilane compound.

22. The titanium dioxide particles according to any one of claims 17-21, wherein the particles have photocatalytic activity, expressed as the formation rate of acetone, of less than 5 ppm/h, preferably less than 1 ppm/h.

23. Use of the titanium dioxide particles of any one of claims 17-22 or the titanium dioxide particle obtained by the method of any one of claims 1-16 for manufacturing plastics, coatings, inks, ultrafine titanium dioxide containing products.
